(19) United States
(12) Patent Application Publication
(10) Pub. No.: US 2010/0055454 A1
(43) Pub. Date: Mar. 4, 2010

(54) Dispersion liquid of metal oxide fine particles,and molded products using the same

(75) Inventor: Yoshio Tadakuma, Ashigarakami-gun (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/461,906

(22) Filed: Aug. 27, 2009

(30) Foreign Application Priority Data
Aug. 28, 2008 (JP) 2008-219751

(51) Int. Cl. B32B 5/16; C09K 3/00

(52) U.S. Cl. 428/338; 252/182.11

(57) ABSTRACT

A dispersion liquid of metal oxide fine particles, including metal oxide fine particles each containing at least titanium, wherein the metal oxide fine particles have a sphere-equivalent average primary particle diameter of 1 nm to 20 nm, and a sphere-equivalent average secondary particle diameter of 20 nm or less, wherein the sphere-equivalent average secondary particle diameter of the metal oxide fine particles is larger than the sphere-equivalent average primary particle diameter thereof by 4 times or less, and wherein the metal oxide fine particles have a water content of 12% or less.

### BACKGROUND OF THE INVENTION

1. Field of the Invention

The present invention relates to a dispersion liquid of metal oxide fine particles used for producing a molded product which needs high transparency, and a molded product using the dispersion liquid of metal oxide fine particles.

2. Description of the Related Art

Recently, optical materials are extensively studied, and especially in the field of lenses, it has been demanded to develop optical materials excellent in high refractivity, heat resistance, light resistance, transparency, easy-to-mold property, lightness, chemical resistance, solvent resistance, and the like.

Plastic lenses are lightweight and unbreakable compared to lenses made of an inorganic material such as glass, and plastic can be formed into lenses having various shapes. Accordingly the plastic lenses are widely and rapidly used not only for eyeglasses but also for optical materials such as lenses for a portable camera and a pickup lens in recent years.

In addition, the material itself is required to have a high refractive index for the purpose of thinning of a lens and downsizing of an image pickup device. Techniques have extensively been studied, for example, a technique in which a sulfur atom is introduced into a polymer (Japanese Patent Application Laid-Open (JP-A) Nos. 2002-131502 and 10-298287), a technique in which a halogen atom or an aromatic ring is introduced into a polymer (JP-A No. 2004-244444), or the like. However, a plastic material, has a sufficient refractive index, excellent transparency and light resistance, and is used alternative to a glass, has not been developed yet. Moreover, in an optical fiber or a light guide, materials having different refractive indexes are used in combination and materials having a distribution of refractive index are used. To cope with these materials in which the refractive index tends to vary depending on the sites, the development of a technique for arbitrarily controlling a refractive index has been demanded.

Since it is difficult to improve a refractive index with organic materials alone, a method has been reported in which the refractive index of a resin is increased by dispersing an inorganic material having a high refractive index in a resin matrix (JP-A No. 2003-73559). Meanwhile, in order to lower the decrease of transmitted light by Rayleigh scattering, it is preferable to uniformly disperse inorganic fine particles having a particle size of 15 nm or less in a resin matrix. However, since a primary particle having a particle size of 15 nm or less is extremely easy to aggregate, it is significantly difficult to disperse it uniformly in the resin matrix. Moreover, in view of the decrease of transmitted light in a light path length that corresponds to the thickness of a lens, the amount of adding inorganic fine particles has to be limited. Thus, it has so far been unable to disperse the inorganic fine particles into the resin matrix at a high concentration without sacrificing the transparency of a resin.

Moreover, JP-A No. 2005-139295 discloses a metal oxide powder having an average particle diameter of 0.1 μm to 2 μm, a BET specific surface area of 2 m²/g to 20 m²/g, and a concentration of isolated OH group on a particle surface of 3 number/nm² to 8 number/nm². However, in this proposal aggregation between particles cannot be sufficiently controlled, and further improvement and development have been demanded currently.

### BRIEF SUMMARY OF THE INVENTION

An object of the present invention is to provide a highly transparent dispersion liquid of metal oxide fine particles by decreasing the density of hydroxyl groups on a particle surface, and suppressing aggregation between particles caused by reaction such as dehydration polymerization, thereby decreasing haze caused by light scattering, and to provide a molded product obtained by using the dispersion liquid of metal oxide fine particles.

The inventors of the present invention have been studied to solve the above problems, and found that when metal oxide fine particles have less water content, the density of hydroxyl (OH) groups on a particle surface is decreased so as to suppress aggregation caused by interaction via OH groups on particle surfaces (for example, dehydration polymerization) and to improve transparency of a dispersion liquid.

The present invention is achieved based on the findings of the inventors of the present invention, and means for solving the above-mentioned problems are as follows.

<1> A dispersion liquid of metal oxide fine particles, containing: metal oxide fine particles each containing at least titanium, wherein the metal oxide fine particles have a sphere-equivalent average primary particle diameter of 1 nm to 20 nm, and a sphere-equivalent average secondary particle diameter of 20 nm or less, wherein the sphere-equivalent average secondary particle diameter of the metal oxide fine particles is larger than the sphere-equivalent average primary particle diameter thereof by 4 times or less, and wherein the metal oxide fine particles have a water content of 12% or less.
<2> The dispersion liquid of metal oxide fine particles according to <1>, wherein the metal oxide fine particles has a light transmittance of 90% or more at a wavelength of 450 nm.
<3> The dispersion liquid of metal oxide fine particles according to <1>, wherein the amount of the metal oxide fine particles is 0.1% by mass to 20% by mass.
<4> The dispersion liquid of metal oxide fine particles according to <1>, further containing water, which amount is 70% by mass or more.
<5> A molded product obtained by molding a composite composition containing a dispersion liquid of metal oxide fine particles and a resin, wherein the dispersion liquid of metal oxide fine particles, contains metal oxide fine particles each containing at least titanium, wherein the metal oxide fine particles have a sphere-equivalent average primary particle diameter of 1 nm to 20 nm, and a sphere-equivalent average secondary particle diameter of 20 nm or less, wherein the sphere-equivalent average secondary particle diameter of the metal oxide fine particles is larger than the sphere-equivalent average primary particle diameter thereof by 4 times or less, and wherein the metal oxide fine particles have a water content of 12% or less.
<6> The molded product according to <5>, wherein the molded product has a water content of 5% or less.
<7> The molded product according to <5>, wherein the molded product has a refractive index of 1.60 or more at a wavelength of 589 nm, and has a light transmittance of 77% or more at a wavelength of 589 nm with respect to a thickness of 1 mm.
<8> The molded product according to <5>, wherein the amount of the metal oxide fine particles is 20% by mass or more.
<9> The molded product according to <5>, wherein the molded product is used as a lens base material.

According to the present invention, the conventional problems can be solved, specifically, the density of hydroxyl groups on a particle surface is decreased, and aggregation between particles formed by a reaction such as dehydration polymerization is suppressed, thereby decreasing haze caused by light scattering, thus, a highly transparent dispersion liquid of metal oxide fine particles, and a molded product obtained by using the dispersion liquid of metal oxide fine particles can be provided.

### DETAILED DESCRIPTION OF THE INVENTION

### Dispersion Liquid of Metal Oxide Fine Particles

The dispersion liquid of metal oxide fine particles of the present invention contains at least metal oxide fine particles, and further contains water, and if necessary, other components.

### —Metal Oxide Fine Particles—

The metal oxide fine particles contain at least Ti, and further contains at least an oxide of a metal selected from the group consisting of Zn, Ge, Zr, Hf, Si, Sn, Mn, Ga, Mo, In, Sb, Ta, V, Y, and Nb, or a complex metal oxide consisting of these metals.

Specific examples of the metal oxide include ZnO, GeO₂, TiO₂, ZrO₂, HfO₂, SiO₂, Sn₂O₃, Mn₂O₃, Ga₂O₃, Mo₂O₃, In₂O₃, Sb₂O₃, Ta₂O₅, V₂O₅, Y₂O₃, and Nb₂O₅.

Examples of the complex metal oxide include a complex oxide of titanium and zirconium; a complex oxide of titanium, zirconium and hafnium; a complex oxide of titanium and barium; a complex oxide of titanium and silicon; a complex oxide of titanium, zirconium and silicon; a complex oxide of titanium and tin; and a complex oxide of titanium, zirconium and tin.

Of these, the complex metal oxide preferably contains 60 at. % or more of titanium with respect to the whole metal atoms, and more preferably contains 70 at. % or more of titanium and tin with respect to the whole metal atoms. With the use of any of these complex metal oxides, a dispersion liquid of metal oxide fine particles having a high refractive index can be obtained.

More specifically, it is preferable that the complex metal oxide consists of oxides of Ti, Sn and Zr, wherein Ti and Sn account for 70 at. % to 98 at. % of the whole metal atoms and Zr accounts for the rest thereof.

It is preferred that an X-ray diffraction pattern of the complex metal oxide indicate a rutile structure.

The surface of the metal oxide fine particles may be coated with a material having a low activity of photocatalyst, or may be further doped with a metal for recoupling electrons and positive holes.

Preferable examples of such metal oxides include TiO₂, ZrO₂ and SnO₂. Of these, TiO₂ is more preferable in terms of the high refractive index. Further, a complex metal oxide of TiO₂ and tin having a rutile structure has a higher refractive index. Particularly preferred is a rutile complex metal oxide of tin and titanium as a core, of which surface is coated with ZrO₂, Al₂O₃, SiO₂, or the like. The fine particles may be metal oxide fine particles, of which surface is modified with a silane coupling agent or titanate coupling agent, aiming at lowering of photocatalytic activity and lowering of water absorption.

A method of producing the metal oxide fine particles is not particularly limited and may be any of conventional methods. For example, a desired oxide fine particle can be obtained by hydrolyzing a metal salt or metal alkoxide used as a raw material in a reaction system containing water.

Examples of the metal salt include chlorides, bromides, iodides, nitrates, sulfates, and organic acid salts, of desired metals. Examples of the organic acid salts include acetates, propionates, naphthenates, octylates, stearates, and oleates. Examples of the metal alkoxides include methoxides, ethoxides, propoxides, and butoxides, of desired metals. As a method of synthesizing the metal oxide fine particles may be used a known method, for example, as described in the Japanese Journal of Applied Physics, vol. 37, p. 4603-4608 (1998), or the Langmuir, vol. 16 (1), p. 241-246 (2000).

Particularly, when the metal oxide fine particles are synthesized by a sol formation method, it is possible to use a procedure in which a precursor such as a hydroxide is firstly formed, and then dehydrocondensed or deflocculated with an acid or an alkali, so as to form a hydrogel, as in the synthesis of titanium oxide fine particles using titanium tetrachloride as a raw material. In such a procedure of firstly forming a precursor, the precursor is preferably isolated and purified by an optional method such as filtration and centrifugal separation in terms of purity of a final product.

In addition to the hydrolysis in water, the metal oxide fine particles may be produced in an organic solvent, or in an organic solvent in which a thermoplastic resin has been dissolved. The solvent used in these methods is not particularly limited and may be appropriately selected depending on the purpose. Examples thereof include acetone, 2-butanone, dichloromethane, chloroform, toluene, ethyl acetate, cyclohexanone, and anisole. These may be used alone or in combination.

The metal oxide fine particles have a sphere-equivalent average primary particle diameter of 1 nm to 20 nm, and more preferably 2 nm to 10 nm. When the sphere-equivalent average primary particle diameter is less than 1 nm, it is hard to obtain sufficient crystallinity, decreasing the refractive index. When it is more than 20 nm, haze caused by light scattering is increased, and in the case where the metal oxide fine particles are used for producing an optical component, the transparency necessary for the optical component may not be obtained.

The metal oxide fine particles have a sphere-equivalent average secondary particle diameter of 20 nm or less, and preferably 2 nm to 10 nm. The sphere-equivalent average secondary particle diameter of the metal oxide fine particles is larger than the sphere-equivalent average primary particle diameter thereof by 4 times or less, and preferably 1 time to 3 times larger than the sphere-equivalent average primary particle diameter thereof.

When the sphere-equivalent average secondary particle diameter is more than 20 nm, the poor transparency of the optical component caused by light scattering may occur, as in the case where the sphere-equivalent average primary particle diameter is more than 20 nm. When the sphere-equivalent average secondary particle diameter exceeds 4 times larger than the sphere-equivalent average primary particle diameter, the number of particles forming secondary particles becomes larger, and water molecules and the like encapsulated inside the aggregation may not be accurately calculated as water content.

Here, the sphere-equivalent average primary particle diameter can be measured by an x-ray diffractometer (XRD), or a transmission electron microscope (TEM).

The sphere-equivalent average secondary particle diameter can be measured by dynamic scattering method using a hypersensitive nanoparticle distribution measurement device (UPA-UT151, manufactured by Nikkiso Co., Ltd.).

When the metal oxide fine particles in the dispersion liquid are fully isolated as primary particles, the particle diameter thereof is equivalent to the primary particle diameter. On the other hand, the metal oxide fine particles are aggregated, particle diameter thereof corresponds to the secondary particle diameter. In these cases, the particle diameters obtained by dynamic scattering method are compared to TEM image observation so as to find which of the particle diameters, i.e. either the primary particle diameter or the secondary particle diameter, is obtained.

The metal oxide fine particles have a water content of 12% or less, and preferably 5% to 10%. When the water content is more than 12%, aggregations between particles become remarkable, large secondary particles which cause light scattering may be formed.

The water content of the metal oxide fine particles can be controlled by heat treatment with addition of acid. Examples of the acids include carboxylic acid, phosphoric acid, and phosphonic acid. Of these, carboxylic acid is particularly preferred. For example, as the carboxylic acid, acetic acid may be used. The heat treatment is performed at 40° C. to 90° C. for 30 minutes or longer.

The water content depends on the density of hydroxyl (OH) groups on the surface of the metal oxide fine particles, and can be measured by a Karl Fischer method.

The dispersion liquid of metal oxide fine particles preferably has a light transmittance of 90% or more. When the light transmittance is less than 90%, the light transmittance of a composite molded product formed from the dispersion liquid of metal oxide fine particles is decreased, and the composite molded product cannot be practically used as an optical component.

The light transmittance is measured in such a manner that the dispersion liquid of metal oxide fine particles are loaded in a quartz cell with an optical path length of 10 mm, and measured at a wavelength of 500 nm by an ultraviolet-visible absorption spectrophotometer (UV-3100, manufactured by Shimadzu Corporation).

The amount of the metal oxide fine particles in the dispersion liquid of metal oxide fine particles is 0.1% by mass to 20% by mass, and preferably 1% by mass to 10% by mass. When the amount of the metal oxide fine particles is less than 0.1% by mass, a large amount of the solution is necessary for production of a molded product, and the removal of the solvent by evaporation or the like may lead to high cost. When the amount is more than 20% by mass, the distance between the metal oxide fine particles becomes closer enough to easily form aggregation of the metal oxide fine particles, causing poor stability over time.

The dispersion liquid of the metal oxide fine particles contains water, and the amount of the water is preferably 70% by mass or more, and more preferably 80% by mass or more. When the amount of water is less than 70% by mass, in the case where a metal alkoxide is used as a raw material for the metal oxide fine particles, gel may be formed under some conditions, which impairs formation of particles each having uniform size, causing poor transparency. When a metal salt is used as a raw material, the amount of water cannot be reduced in terms of solubility. Moreover, when the amount of water is small, an apparatus such as an electrodialytic apparatus cannot be used in the desalting process, and so the desalting may be constrained.

### (Molded Product)

The molded product of the present invention is obtained by molding a composite composition containing the dispersion liquid of the metal oxide fine particles and a resin, and if necessary, other components.

The molded product preferably has a water content of 5% or less, and more preferably 0.5% to 2%. When the water content is more than 5%, the volume of the molded product is changed by expansion and vaporization under high temperature conditions. Thus, deformation is occurred in the molded product, causing poor transparency by light scattering.

Here, the water content of the molded product can be measured by a Karl Fischer method in the same manner as in that of the metal oxide fine particles.

The refractive index of the molded product at a wavelength of 589 nm is preferably 1.60 or more, more preferably 1.65 or more, and still more preferably 1.67 or more. In order to thin the lens or to downscale a shooting unit, a lens material is desired to have a high refractive index. A commercially available thermoplastic resin has a refractive index of approximately 1.6. When the refractive index of the molded product is less than 1.60, there is no merit for forming a molded product a composite material in terms of costs, because a resin alone can achieve such refractive index.

The refractive index can be determined by an Abbe refractometer (DM-M4, manufactured by Atago Co., Ltd.) with light having a wavelength of 589 nm.

The light transmittance of the molded product with respect to a thickness of 1 mm at a wavelength of 589 nm is preferably 77% or more, more preferably 80% or more. When the light transmittance is 77% or more, a lens base material having excellent properties can be easily obtained.

The light transmittance of the molded product with respect to a thickness of 1 mm is obtained by preparing a base plate having a thickness of 1.0 mm and measuring it with an ultraviolet-visible absorption spectrophotometer (UV-3100, manufactured by Shimadzu Corporation).

The amount of the metal oxide fine particles in the molded product is preferably 20% by mass or more, and more preferably 30% by mass to 50% by mass. When the amount is less than 20% by mass, a molded product having a sufficiently high refractive index may not be obtained.

Although the composite composition that forms the molded product of the present invention contains a resin and the metal oxide fine particle of the present invention as essential components, and if necessary, some additives such as another resin, a dispersant, a plasticizer, and a releasing agent may also be contained.

The composite composition preferably has a glass transition temperature of 100° C. to 400° C., more preferably 130° C. to 380° C. This is because that sufficient heat resistance can be obtained at a glass transition temperature of 100° C. or higher and that a molding process tends to be easily performed at a glass transition temperature of 400° C. or lower.

### <Resin>

The resin is not particularly limited and may be appropriately selected depending on the purpose. Examples thereof include a thermoplastic resin and a hardening resin.

### —Thermoplastic Resin—

The thermoplastic resin is not particularly limited and may be appropriately selected depending on the purpose. Examples thereof include poly(meth)acrylate, polystyrene, polyamide, polyvinylether, polyvinylester, polyvinylcarbazol, polyolefin, polyester, polycarbonate, polyurethane, polythiourethane, polyimide, polyether, polythioether, polyetherketone, polysulfone, and polyethersulfone. These resins may be used alone or in combination.

As the thermoplastic resin, it is preferable to use a thermoplastic resin having a functional group, which can form a chemical bond with metal oxide fine particles at a terminal or a side chain, from a point of view that such thermoplastic resin can prevent the metal oxide fine particles from aggregation to thereby realize uniform dispersion. As such functional groups, those expressed by the following formulas are preferable.

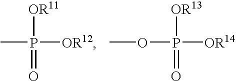

In the above formulas, R¹¹, R¹², R¹³, and R¹⁴ each independently represent a hydrogen atom, a substituted or unsubstituted alkyl group, a substituted or unsubstituted alkenyl group, a substituted or unsubstituted alkynyl group, a substituted or unsubstituted aryl group, —SO₃H, —OSO₃H, —CO₂H, or Si(OR¹⁵)ₘ₁R¹⁶₃₋ₘ₁ (where R¹⁵ and R¹⁶ represent each independently a hydrogen atom, a substituted or unsubstituted alkyl group, a substituted or unsubstituted alkenyl group, a substituted or unsubstituted alkynyl group, or a substituted or unsubstituted aryl group, and m1 is an integer of 1 to 3).

Here, examples of the chemical bond include a covalent bond, an ionic bond, a coordination bond, and a hydrogen bond. When there are a plurality of functional groups, each functional group may form a different kind of chemical bond with the metal oxide fine particles. Whether or not to form a chemical bond is judged from whether or not the functional group of the thermoplastic resin forms a chemical bond with metal oxide fine particles, when the thermoplastic resin is mixed with the metal oxide fine particles in the organic solvent. The functional groups may, partly or wholly, bind chemically to the metal oxide fine particles.

The thermoplastic resin has a mass average molecular mass of preferably 1,000 to 500,000, more preferably 3,000 to 300,000, and still more preferably 10,000 to 100,000. When the mass average molecular mass is 500,000 or less, the molding processability tends to be enhanced, and when the mass average molecular mass is 1,000 or more, a mechanical strength tends to be enhanced.

Here, the mass average molecular mass of the thermoplastic resin is a molecular mass determined as a polystyrene conversion by using a GPC analyzer with a column such as TSKGEL GMHXL, TSKGEL G4000HXL, or TSKGEL G2000HXL (trademarks of the products of Tosoh Corporation), tetrahydrofuran as a solvent, and a differential refractometer detector.

In the thermoplastic resin, the number of the functional groups that bind to the metal oxide fine particles is preferably 0.1 to 20, more preferably 0.5 to 10, and still more preferably 1 to 5, on average per one polymer chain. When the average number of the functional groups is 20 or less per one polymer chain, the thermoplastic resin adheres to a plurality of metal oxide fine particles, thereby preventing occurrence of high viscosity and gelling in a solution state. When the average number of the functional groups per one polymer chain is 0.1 or more, the metal oxide fine particles may be easily stably dispersed.

The thermoplastic resin has a glass transition temperature of preferably 80° C. to 400° C., more preferably 130° C. to 380° C. Use of a thermoplastic resin having a glass transition temperature of 80° C. or higher enables to easily obtain optical components having sufficient thermal resistance. Use of a thermoplastic resin having a glass transition temperature of 400° C. or lower enables to enhance molding processability.

### —Hardening Resin—

As the hardening resin, a known resin having a structure that is hardened by heat or active energy line may be used. Specific examples thereof include monomers and prepolymers, having a radical-reactive group (e.g., an unsaturated group such as (meth)acryloyl group, styryl group, and allyl group), a cationic-reactive group (e.g., epoxy group, oxetanyl group, episulfide, and oxazolyl), and a reactive silyl group (e.g., alkoxysilyl group).

Moreover, a sulfur-containing hardening resin is also preferably used, which is disclosed in JP-A Nos. 05-148340, 05-208950, 06-192250, 07-252207, 09-110979, 09-255781, 10-298287, 2001-342252, and 2002-131502.

In addition to the above-described resins and metal oxide fine particles, various additives may be incorporated into the composite composition, in order to improve uniform dispersibility, flowability, releasability and weather resistance in the molding process. Further, in addition to the above-mentioned resin, resins having no such functional group may be added. The types of these resins are not particularly limited, and it is preferred that resins have an optical property, thermal property, and molecular mass, similar to those of the above-mentioned resins.

A mixing ratio of the additives varies depending on the purpose. However, in general, the ratio is preferably 50% by mass or less, more preferably 30% by mass or less, and particularly preferably 20% by mass or less, with respect to the total amount of the metal oxide fine particles and the thermoplastic resin.

As will be mentioned later, when the resin is mixed with the metal oxide fine particle which is dispersed in water or an alcohol solvent, a surface treatment agent for the fine particles other than the above resins may be added for the various purposes, including enhancing extraction property to an organic solvent or substitution property; enhancing uniform dispersibility in the resin; lowering the water absorption of the fine particles; and enhancing weather resistance. The surface treatment agent has a mass average molecular mass of preferably 50 to 50,000, more preferably 100 to 20,000, and still more preferably 200 to 10,000.

As the surface treatment agent, those having a structure expressed by General Formula (1) are preferably used.

A-B General Formula (1)

In General Formula (1), A is a functional group capable of forming any chemical bond to the surface of metal oxide fine particles of the present invention, and B is a C₁-C₃₀ monovalent group or a polymer which is compatible or reactive with a resin matrix containing the resin of the present invention as a main component. Here, examples of the chemical bond include a covalent bond, ionic bond, coordinate bond, and hydrogen bond.

Preferable examples of the group represented by A are the same as the functional groups introduced to the resin so as to bind to the fine particles.

Meanwhile, the chemical structure of B is preferably the same as or similar to the chemical structure of the resin which is a main body of the resin matrix, in terms of compatibility. In the present invention, it is preferred that the chemical structure of B has an aromatic ring in terms of high refractive index.

The surface treatment agent is not particularly limited, and may be appropriately selected depending of the purpose. Examples thereof include p-octyl benzoic acid, p-propyl benzoic acid, acetic acid, propionic acid, cyclopentanecarboxylic acid, dibenzyl phosphate, monobenzyl phosphate, diphenyl phosphate, di-α-naphthyl phosphate, phenyl phosphonic acid, phenyl phosphonic acid monophenyl ester, KAYAMER PM-21 (trade name, manufactured by Nippon Kayaku Co., Ltd.), KAYAMER PM-2 (trade name, manufactured by Nippon Kayaku Co., Ltd.), benzene sulfonate, naphthalene sulfonate, paraoctylbenzene sulfonate, or a silane coupling agent as described in Japanese Patent Application Laid-Open (JP-A) Nos. 05-221640, 09-100111, and 2002-187921.

These surface treatment agents may be used alone or in combination. The total amount of the surface treatment agent on a mass basis is preferably 0.01 times to 2 times, more preferably 0.03 times to 1 time, still more preferably 0.05 times to 0.5 times, with respect to the metal oxide fine particle.

When the resin of the present invention has a high glass transition temperature, the composite composition may not be easily molded. In such a case, a plasticizer may be used to lower the molding temperature of the composite composition. An amount of the plasticizer is preferably 1% by mass to 50% by mass, more preferably 2% by mass to 30% by mass, and still more preferably 3% by mass to 20% by mass, based on the total amount of the composite composition constituting a transparent molded product.

The plasticizer needs to be selected with consideration of compatibility with a resin, weather resistance, plasticizing effect, and the like in total. An optimum plasticizer cannot be defined, because it depends on other components. But in terms of the refractive index, it is preferred to use those having an aromatic ring. As a typical example, a compound expressed by General Formula (2) is preferred.

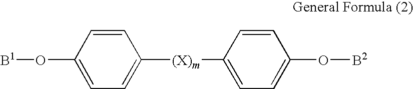

In the General Formula (2), B¹ and B² each represent a C₆-C₁₈ alkyl group or a C₆-C₁₈ arylalkyl group, m is 0 or 1, x is one of the following divalent bonding groups.

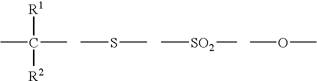

where, R¹ and R² each represent a hydrogen atom or an alkyl group.

In the compound expressed by General Formula (2), B¹ and B² are respectively selected from any alkyl or arylalkyl group, which has carbon atoms ranging from 6 to 18. When the carbon atom is less than 6, the molecular mass is so small that the compounds boil at a melting point of the polymer, generating air bubbles. When the carbon atom exceeds 18, compatibility with the polymer may be poor, failing to exhibit sufficient effect of addition of the plasticizer.

Examples of B¹ or B² include liner alkyl groups such as an n-hexyl group, n-octyl group, n-decyl group, n-dodecyl group, n-tetradecyl group, n-hexadecyl group, and n-octadecyl group; branched alkyl groups such as a 2-hexyldecyl group, and methyl-branched octadecyl group; and arylalkyl groups such as a benzyl group and 2-phenylethyl group.

Specific examples of the compounds expressed by General Formula (2) include the following compounds. Of these, W-1 (KP-L155, manufactured by Kao Corporation) is preferable.

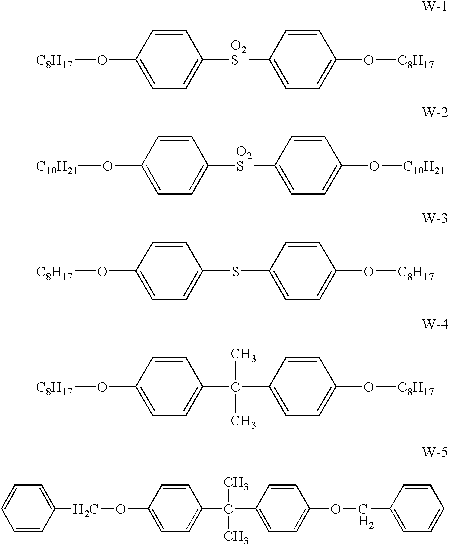

In the composite composition, besides the above components, a known releasing agent such as a modified silicone oil is added to improve molding performance, or a known antidegradant such as hindered phenol, amine, phosphorus, and thioether is added to improve light resistance or to decrease thermal deterioration. An amount of these components is preferably 0.1% by mass to 5% by mass based on all the solid content of the composite composition.

### —Method of Producing Composite Composition—

The metal oxide fine particles as used in the present invention are bound to the resin having the functional group at the side chain so as to disperse in a resin.

The metal oxide fine particles used in the present invention have a small particle diameter and a high surface energy, so that if they are isolated as a solid, it is difficult to disperse them again. Thus, it is preferable that the metal oxide fine particles be dispersed in the solution and mixed with the resin to obtain a stable dispersion. Examples of preferable methods of producing the composite composition include (1) a method in which the surface of the metal oxide fine particles are treated with the above-mentioned surface treatment agent, and the surface-treated metal oxide fine particles are extracted with an organic solvent, and then the extracted metal oxide fine particles are uniformly mixed with the resin, to thereby yield a composite composition of the metal oxide fine particles and the resin; and (2) a method in which the metal oxide fine particles and the resin are uniformly mixed with the use of a solvent capable of uniformly dispersing or dissolving the metal oxide fine particles and the resin, to thereby yield a composite composition thereof.

When the composite composition of metal oxide fine particles and the resin is produced by the method (1), an organic solvent to be used is preferably a water-insoluble organic solvent such as toluene, ethyl acetate, methyl isobutyl ketone, chloroform, dichloroethane, chlorobenzene, and methoxybenzene. The surface treatment agent to be used for the extraction of the fine particles to the organic solvent and the resin may be of the same type or different type. The surface treatment agent is preferably any of those referred to previously in the description of the surface treatment agents.

When the metal oxide fine particles extracted to the organic solvent and the resin are mixed, any additive such as a plasticizer, a releasing agent, a different type of polymer or the like may be added, as necessary.

In the case of the method (2), examples of the solvents preferably used include hydrophilic polar solvents such as dimethylacetamide, dimethylformamide, dimethylsulfoxide, benzylalcohol, cyclohexanol, ethyleneglycol monomethylether, 1-methoxy-2-propanol, t-butanol, acetic acid, and propionic acid, alone or in combination; or mixed solvents of the polar solvent and a water-insoluble solvent such as chloroform, dichloroethane, dichloromethane, ethylacetate, methyl ethyl ketone, methyl isobutyl ketone, toluene, chlorobenzene and methoxybenzene. Here, in addition to those used in the resin, a dispersant, a plasticizer, a releasing agent, or another polymer may be used, if necessary. When fine particles dispersed in a mixture of water and methanol are to be used, a hydrophilic solvent, which has a boiling point higher than that of the mixture of water and methanol, and dissolves a thermoplastic resin, is preferably added, and the mixture of water and methanol is condensed and removed so as to substitute the dispersion liquid of fine particles for the polar organic solvent, and then the fine particles are mixed with the resin. In this process, the surface treatment agent may be added.

The solution of the composite composition obtained by the method (1) or (2) can be directly cast-molded to obtain a transparent molded product. In the present invention, the molded product can be preferably produced by a method, in which a solvent is removed from the solution of the composite composition by a technique such as condense, or freeze-drying, or reprecipitation from an appropriate poor solvent, and then a solid content of powder is molded by a technique such as injection molding, compression molding, or the like.

By molding the composite composition, the molded product of the present invention can be produced. Of the molded products of the present invention, those having the refractive index and the optical performance as described in regard to the composite composition are useful.

The molded product of the present invention is particularly advantageously used for optical components having a thickness of 0.1 mm or more and having a high refractive index, more preferably for those having a thickness of 0.1 mm to 5 mm, particularly preferably for transparent components having a thickness of 1 mm to 3 mm.

Generally, such a thick molded product is not easy to be produced by a solution casting process because the solvent is hard to be removed sufficiently. However, the composite composition used in the present invention is easy to mold and easy to form a complicated shape such as a non-spherical surface, can provide a product having an excellent transparency by utilizing high refractive index performance of the metal oxide fine particles.

The optical component using the molded product of the present invention is not particularly limited as long as the optical component utilizes the excellent optical performance of the composite composition, and may be appropriately selected depending on the purpose. For example, the molded product can be used as lens base materials, particularly light transmissive optical components (so-called, passive optical components). Examples of optical functional devices equipped with such optical components include various display devices (e.g., liquid crystal displays and plasma displays), various projector devices (e.g., OHPs and liquid crystal projectors), optical fiber communication devices (e.g., optical waveguides and optical amplifiers), and photographic devices such as cameras and videos. Examples of the passive optical components used in the optical functional devices include lenses, prisms, prism sheets, panels, films, optical waveguides, optical discs, and sealants of LED.

The molded product of the present invention is particularly suitable for a lens base material. The lens base material using the molded product of the present invention is excellent in optical performances, having high refractive index, light transmittance, and light weight property simultaneously. The refractive index of the lens base material can be arbitrarily adjusted by appropriately changing the type of the monomer constituting the composite composition or by regulating the amount of the metal oxide fine particles to be dispersed.

The “lens base material” means a single member that achieves a function of lens. On the surface of lens base material or at the circumference of lens base material, a film or a member can be provided according to circumstances or applications of the lens. For example, on the surface of lens base material, a protective film, an antireflection film, or a hard-coat film can be formed. Moreover, the lens base material can be fixed by putting the periphery of the lens base material into a base material retaining frame. However, these films or frames are additional members added to the lens base material, which are distinguished from the lens base material itself.

When using the lens base material as a lens, the lens base material may be used alone as a lens, or may be used as a lens accompanied with the film or frame as described above. The type or shape of the lens using the lens base material is not particularly limited. The lens base material of the present invention is used, for example, for lenses for spectacles, optical instruments, optoelectronics, laser, pickup, onboard cameras, portable cameras, digital cameras, OHPs, microlens arrays or the like.

### EXAMPLES

Hereinafter, the present invention will be explained by way of Examples, which should not be construed as limiting the present invention thereto.

In Examples, an X-ray diffraction spectrum and mass average molecular mass were measured as follows.

### <Measurement of X-ray Diffraction (XRD) Spectrum>

The X-ray diffraction (XRD) spectrum was measured at 23° C. using RINT1500 (manufactured by Rigaku Corporation) (X-ray source: cupper Kα-line; wavelength: 1.5418 Å (0.15418 nm)).

### <Measurement of Mass Average Molecular Mass>

The mass average molecular mass is a molecular mass determined as a polystyrene conversion by using a GPC analyzer with a column such as TSKGEL GMHXL, TSKGEL G4000HXL, or TSKGEL G2000HXL (trademarks of the products of Tosoh Corporation), tetrahydrofuran as a solvent, and a differential refractometer detector.

### Example 1

### Preparation of Dispersion Liquid of Metal Oxide Fine Particles 1

With 12 mL of ethanol 0.0473 mole of titanium tetraisopropoxide was mixed and stirred at room temperature, and 2 mL of concentrated hydrochloric acid was dripped to the mixture to obtain a transparent solution. Meanwhile, 0.00591 mole of tin(IV) chloride pentahydrate was dissolved in 101.3 g of water at room temperature so as to prepare a solution. These solutions were mixed and stirred for a while at room temperature to obtain a transparent solution. The solution was then heated in a water bath kept at a temperature of 70° C. for 60 minutes with stirring, to thereby obtain a translucent sol with slight white turbidity. Zirconium chloride oxide octahydrate (0.0236 mole) was dissolved in 50 mL of water at room temperature, and the resultant aqueous solution was added to the sol, which was heating in the water bath, for 40 minutes. After completion of the addition, the sol was subjected to aging at 80° C. for 80 minutes. While the sol was kept at 80° C., 2 mL of acetic acid was added in the sol and stirred for 30 minutes, and then cooled down to room temperature to thereby prepare a transparent dispersion liquid of metal oxide fine particles 1.

An X-ray diffraction (XRD) analysis revealed that the obtained dispersion liquid contained fine particles having a rutile structure. The dispersion liquid was desalinated by ultrafiltration to adjust a concentration of the metal oxide fine particles to 4% by mass.

### Example 2

### Preparation of Dispersion Liquid of Metal Oxide Fine Particles 2

A transparent dispersion liquid of metal oxide fine particles 2 having 4% by mass of the metal oxide fine particles was prepared in the same manner as in Example 1, except that 2 mL of acetic acid in Example 1 was replaced with 4 mL of acetic acid.

An X-ray diffraction (XRD) analysis revealed that the obtained dispersion liquid contained fine particles having a rutile structure.

### Example 3

### Preparation of Dispersion Liquid of Metal Oxide Fine Particles 3

A transparent dispersion liquid of metal oxide fine particles 3 having 4% by mass of the metal oxide fine particles was prepared in the same manner as in Example 1, except that 0.00591 mole of tin(IV) chloride pentahydrate dissolved in 101.3 g of water in Example 1 was replaced with 0.01773 mole of tin(IV) chloride pentahydrate dissolved in 143.5 mL of water.

An X-ray diffraction (XRD) analysis revealed that the obtained dispersion liquid contained fine particles having a rutile structure.

### Example 4

### Preparation of Dispersion Liquid of Metal Oxide Fine Particles 4

A transparent dispersion liquid of metal oxide fine particles 4 having 6% by mass of the metal oxide fine particles was prepared in the same manner as in Example 1, except that 0.00591 mole of tin(IV) chloride pentahydrate dissolved in 101.3 g of water in Example 1 was replaced with 0.00591 mole of tin(IV) chloride pentahydrate dissolved in 44 mL of water.

An X-ray diffraction (XRD) analysis revealed that the obtained dispersion liquid contained fine particles having a rutile structure.

### Comparative Example 1

### Preparation of Dispersion Liquid of Metal Oxide Fine Particles 5

A translucent dispersion liquid of metal oxide fine particles 5 with slight white turbidity having 4% by mass of the metal oxide fine particles was prepared in the same manner as in Example 1, except that 2 mL of acetic acid in Example 1 was replaced with 2 mL of nitric acid.

An X-ray diffraction (XRD) analysis revealed that the obtained dispersion liquid contained fine particles having a rutile structure.

### Comparative Example 2

### Preparation of Dispersion Liquid of Metal Oxide Fine Particles 6

With 12 mL of ethanol 0.0473 mole of titanium tetraisopropoxide was mixed and stirred at room temperature, and 2 mL of concentrated hydrochloric acid was is dripped to the mixture to obtain a transparent solution. Meanwhile, 0.00591 mole of tin(IV) chloride pentahydrate was dissolved in 101.3 g of water so as to prepare a solution at room temperature. These solutions were mixed and stirred for a while at room temperature to obtain a transparent solution. The solution was heated at 180° C. for 60 minutes in a heat and pressure-resistant container with stirring, to thereby obtain a translucent white sol. In 50 mL of water, 0.0236 mole of zirconium chloride oxide octahydrate was dissolved at room temperature, and the resultant aqueous solution was added to the translucent white sol, which was heating in the water bath, for 40 minutes. After completion of the addition, the sol was subjected to aging at 80° C. for 80 minutes. While the sol was kept at 80° C., 2 mL of acetic acid was added in the sol and stirred for 30 minutes, and then cooled down to room temperature to thereby prepare a transparent dispersion liquid of metal oxide fine particles 6.

An X-ray diffraction (XRD) analysis revealed that the obtained dispersion liquid contained fine particles having a rutile structure. The dispersion liquid was desalinated by ultrafiltration to adjust a concentration of the metal oxide fine particles to 4% by mass.

### Comparative Example 3

### Preparation of Dispersion Liquid of Metal Oxide Fine Particles 7

A dispersion liquid of metal oxide fine particles 7 with white turbidity having 4% by mass of the metal oxide fine particles was prepared in the same manner as in Example 1, except that the heat treatment at 70° C. for 60 minutes in the water bath with stirring in Example 1 was replaced with heat treatment at 70° C. for 120 minutes with stirring.

An X-ray diffraction (XRD) analysis revealed that the obtained dispersion liquid contained fine particles having a rutile structure.

### Comparative Example 4

### Preparation of Dispersion Liquid of Metal Oxide Fine Particles 8

A dispersion liquid of metal oxide fine particles 8 with white turbidity having 4% by mass of metal oxide fine particles was prepared in the same manner as in Example 1, except that 2 mL of acetic acid in Example 1 was replaced with 1 mL of acetic acid.

An X-ray diffraction (XRD) analysis revealed that the obtained dispersion liquid contained fine particles having a rutile structure.

Next, a sphere-equivalent average primary particle diameter, sphere-equivalent average secondary particle diameter, water content, and light transmittance of the obtained dispersion liquids of metal oxide fine particles 1 to 8 were measured. The results are shown in Table 1.

### <Measurement of Sphere-Equivalent Average Primary Particle Diameter>

The average primary particle diameter of metal oxide fine particles contained in each of the dispersion liquids of metal oxide fine particles was measured using H-9000 UHR TRANSMISSION ELECTRON MICROSCOPE (manufactured by Hitachi Ltd.) (Acceleration voltage: 200 kV; the degree of vacuum: 7.6×10⁻⁹ Pa).

### <Measurement of Sphere-Equivalent Average Secondary Particle Diameter>

The average secondary particle diameter of metal oxide fine particles contained in each of the dispersion liquids of metal oxide fine particles was measured using a hyper sensitive nanoparticle distribution measurement device (UPA-UT151, manufactured by Nikkiso Co., Ltd.).

### <Measurement of Water Content>

The unnecessary salts in each of the dispersion liquids of metal oxide fine particles were appropriately desalinated by electrodialysis or ultrafiltration, and then dried and solidified, and left for standing for 24 hours in an atmosphere conditioned at 25° C. and 80% RH so as to prepare a sample. The sample was measured at 150° C. using Karl Fischer Volumetric Titrator (AQUACOUNTER AQV-2100 manufactured by Hiranuma Sangyo Co., Ltd.).

### <Measurement of Light Transmittance>

The light transmittance of each dispersion liquid at an optical path length of 10 mm and a wavelength of 500 nm was measured using an ultraviolet-visible absorption spectrophotometer UV-3100 (manufactured by Shimadzu Corporation).

TABLE 1

| | Sphere-equivalent | Sphere-equivalent | | | Transmittance |
|---|---|---|---|---|---|
| | average primary | average secondary | | Water | of dispersion |
| | particle diameter: A | particle diameter: B | B/A | content | liquid |
| Ex. 1 | 2 nm | 5 nm | 2.5 times | 11% | 90% |
| Ex. 2 | 2 nm | 5 nm | 2.5 times | 9% | 93% |
| Ex. 3 | 3 nm | 4 nm | 1.3 times | 6% | 95% |
| Ex. 4 | 2 nm | 6 nm | 3 times | 11% | 90% |
| Comp. Ex. 1 | 2 nm | 5 nm | 2.5 times | 20% | 80% |
| Comp. Ex. 2 | 30 nm | 100 nm | 3.3 times | 3% | 5% |
| Comp. Ex. 3 | 2 nm | 20 nm | 10 times | 11% | 10% |
| Comp. Ex. 4 | 2 nm | 5 nm | 2.5 times | 15% | 85% |

### Production Example 1

### Preparation of Dispersion of Metal Oxide Fine Particles, N,N′-dimethylacetamide 1

To a solution obtained by adding 1.2 g of p-octylbenzoic acid in 500 g of N,N′-dimethylacetamide, 1,400 g of the dispersion liquid of metal oxide fine particles prepared in Example 1 was added. The mixture was concentrated under reduced pressure so as to adjust the amount of the mixture to about 500 g or less, thereby performing solvent substitution. Thereafter, N,N′-dimethylacetamide was added to the mixture to adjust the concentration thereof, to thereby obtain a dispersion containing 15% by mass of metal oxide fine particles, N,N′-dimethylacetamide 1.

### Production Examples 2, 3 and 5 to 8

### Production of Dispersions of Metal Oxide Fine Particles, N,N′-dimethylacetamide 2, 3 and 5 to 8

Dispersions of metal oxide fine particles, N,N′-dimethylacetamide 2, 3 and 5 to 8 were prepared in the same manner as in Production Example 1, except that the dispersion liquids of metal oxide fine particles prepared in Example 1 was replaced with the dispersion liquids of metal oxide fine particles prepared in Examples 2, 3 and Comparative Examples 1 to 3.

### Production Example 4

### Preparation of Dispersion of Metal Oxide Fine Particles, N,N′-dimethylacetamide 4

A dispersion of metal oxide fine particles, N,N′-dimethylacetamide 4 was prepared in the same manner as in Production Example 1, except that 1,400 g of the dispersion liquid of metal oxide fine particles prepared in Example 1 was replaced with 933 g of the dispersion liquid of metal oxide fine particles prepared in Example 4.

### Synthesis Example 1

### Synthesis of Thermoplastic Resin

In 107.1 g of ethyl acetate, 247.5 g of styrene, 2.5 g of β-carboxyethylacrylate, and 2.5 g of a polymerization initiator (V-601, manufactured by Wako Pure Chemicals Industries, Ltd.) were dissolved, and polymerization was effected at 80° C. in a nitrogen atmosphere to thereby obtain a thermoplastic resin. The thermoplastic resin was measured by a GPC and found to have a mass average molecular mass of 35,000. The refractive index of the thermoplastic resin measured by Abbe refractomer was 1.59.

### Examples 5 to 8 and Comparative Examples 5 to 8

### Preparations of Composition and Production of Transparent Molded Product

To the dispersion of metal oxide fine particles, N,N′-dimethylacetamide 1 to 8 prepared in Production Examples 1 to 8, a thermoplastic resin, n-octyl benzoic acid, and KP-L155 (manufactured by Kao Corporation) were added, such that the mass ratio of a solid content of metal oxide fine particles:the thermoplastic resin:n-octyl benzoic acid:KP-L155 was 41.7:36.7:6.1:12.2. Then, the mixture was stirred uniformly, and heated under reduced pressure, to thereby concentrate the solvent of dimethylacetamide. The concentrated residue was subjected to a thermal compression molding at a temperature of 180° C. and a pressure of 13.7 MPa for 2 minutes so as to produce a transparent molded product as a lens base material having a thickness of 1 mm.

Next, the properties of the obtained molded products were evaluated as follows. The results are shown in Table 2.

### <Measurement of Water Content of Molded Product>

Each of the molded products was pulverized and left for standing for 24 hours in an atmosphere conditioned at 25° C. and 80% RH so as to prepare a sample in the same manner as in the measurement of water content of metal oxide fine particles. The sample was measured at 150° C. using Karl Fischer Volumetric Titrator (AQUACOUNTERAQV-2100 manufactured by Hiranuma Sangyo Co., Ltd.).

### <Measurement of Light Transmittance of Molded Product>

The light transmittance of the molded product was measured in such a manner that a base plate having a thickness of 1.0 mm was prepared and measured using an ultraviolet-visible absorption spectrophotometer (UV-3100, manufactured by Shimadzu Corporation).

### <Measurement of Refractive Index of Molded Product>

The refractive index of each of the molded products was measured by an Abbe refractometer (DR-M4, manufactured by Atago Co., Ltd.) using a light having a wavelength of 589 nm.

TABLE 2

| | | | | Transmission of molded |
|---|---|---|---|---|
| | Dispersion | Water content of | Refractive index of | product having a |
| | liquid | molded product | molded product | thickness of 1 mm |
| Ex. 5 | Ex. 1 | 1.40% | 1.68 | 87% |
| Ex. 6 | Ex. 2 | 1.00% | 1.68 | 89% |
| Ex. 7 | Ex. 3 | 0.80% | 1.65 | 90% |
| Ex. 8 | Ex. 4 | 1.40% | 1.68 | 87% |
| Comp. Ex. 5 | Comp. Ex. 1 | 2.50% | 1.68 | 70% |
| Comp. Ex. 6 | Comp. Ex. 2 | 0.70% | unmeasurable | 0% |
| Comp. Ex. 7 | Comp. Ex. 3 | 1.40% | unmeasurable | 6% |
| Comp. Ex. 8 | Comp. Ex. 4 | 2.00% | 1.68 | 76% |

The molded product obtained by molding a composite composition containing a dispersion liquid of metal oxide fine particles of the present invention and a resin, has both a light transmittance and light weight property, and can be relatively easily provide a lens or the like, which can arbitrarily adjust a refractive index. Moreover, a lens having excellent mechanical strength, thermal resistance, and light resistance can be provided. Therefore, the molded product of the present invention is useful for providing a wide variety of optical components, including a lens base material which constitutes lenses for spectacles, optical instruments, optoelectronics, laser, pickup, onboard cameras, portable cameras, digital cameras, OHPs, or microlens arrays, and thus the molded product of the present invention has excellent industrial applicability.

What is claimed is:

1. A dispersion liquid of metal oxide fine particles, comprising:
metal oxide fine particles each containing at least titanium,
wherein the metal oxide fine particles have a sphere-equivalent average primary particle diameter of 1 nm to 20 nm, and a sphere-equivalent average secondary particle diameter of 20 nm or less,
wherein the sphere-equivalent average secondary particle diameter of the metal oxide fine particles is larger than the sphere-equivalent average primary particle diameter thereof by 4 times or less, and
wherein the metal oxide fine particles have a water content of 12% or less.

2. The dispersion liquid of metal oxide fine particles according to claim 1, wherein the metal oxide fine particles has a light transmittance of 90% or more at a wavelength of 450 nm.

3. The dispersion liquid of metal oxide fine particles according to claim 1, wherein the amount of the metal oxide fine particles is 0.1% by mass to 20% by mass.

4. The dispersion liquid of metal oxide fine particles according to claim 1, further comprising water, which amount is 70% by mass or more.

5. A molded product obtained by molding a composite composition comprising a dispersion liquid of metal oxide fine particles and a resin,
wherein the dispersion liquid of metal oxide fine particles, comprises:
metal oxide fine particles each containing at least titanium,
wherein the metal oxide fine particles have a sphere-equivalent average primary particle diameter of 1 nm to 20 nm, and a sphere-equivalent average secondary particle diameter of 20 nm or less,
wherein the sphere-equivalent average secondary particle diameter of the metal oxide fine particles is larger than the sphere-equivalent average primary particle diameter thereof by 4 times or less, and
wherein the metal oxide fine particles have a water content of 12% or less.

6. The molded product according to claim 5, wherein the molded product has a water content of 5% or less.

7. The molded product according to claim 5, wherein the molded product has a refractive index of 1.60 or more at a wavelength of 589 nm, and has a light transmittance of 77% or more at a wavelength of 589 nm with respect to a thickness of 1 mm.

8. The molded product according to claim 5, wherein the amount of the metal oxide fine particles is 20% by mass or more.

9. The molded product according to claim 5, wherein the molded product is used as a lens base material.
